(19) United States
(12) Patent Application Publication
(10) Pub. No.: US 2006/0236529 A1
(43) Pub. Date: Oct. 26, 2006

(54) Device for assembling heat conductive tubes to heat dissipating plates

(76) Inventor: Zhi Mieng Tai, Taipei (TW)

Correspondence Address: ZHI MIENG TAI, 235 Chung-Ho, Box 8-24, Taipei, TW

(21) Appl. No.: 11/272,944

(22) Filed: Nov. 15, 2005

(30) Foreign Application Priority Data
Apr. 20, 2005 (TW) 094206217

(51) Int. Cl. B23P 15/26

(52) U.S. Cl. 29/726

(57) ABSTRACT

A device for assembling a heat conductive tube to a heat dissipating plate comprises a retaining seat; a transmission device; a displace unit firmly secured to the retaining seat; the displace unit having a seat; a transmission element being installed to the seat; one end of the transmission element being extended to be out of the seat so as to be assembled to the transmission device; the transmission element being pivotally installed with a movable unit; a guide unit firmly secured to the retaining seat; the guide unit having a guide track and a movable block slideable upon the guide track; and a carrying unit having a connecting block, a supporting plate, an adjusting plate, and a locking element; the connecting block being firmly secured to the movable unit, and the movable block.

### FIELD OF THE INVENTION

The present invention relates to heat dissipating device, and particularly to the assembly of the heat conductive tube and heat dissipating sheet is design to cause that when the heat conductive tubes pass through heat dissipating sheets of different specifications. The spacing between the heat dissipating sheets can be adjusted easily. Furthermore, the shift in the connection between the heat conductive tube and the heat dissipating sheet can be reduced and the noise is decreased. Thus, the heat dissipating sheet can be arranged densely.

### BACKGROUND OF THE INVENTION

Currently technology for combing a heat conductive tube to a heat dissipating sheet is performed by punching the heat dissipating sheet on a machine table by using a punching device and by using a connection device for clamping the heat conductive tube to move upwards or downwards. The punching device serves to punch metal material into a heat dissipating sheet. A plurality of heat dissipating sheets are engaged with at least one heat conductive tube so that the heat conductive tube and the heat dissipating sheets are formed as an integral heat conductive device.

Referring to FIG. 12, in the portion connecting device, a lifting seat A has one side installed with a fixture A1 for clamping the heat conductive tube so that the heat conductive tube B can be engaged with the heat dissipating sheet C by the lifting and descending of the seat. A bottom of the seat is fixed with a positioning post A2. A lower side of the post A2 is installed with a stepped block A3 which can move linearly. Thereby when each time, the seat A lifts and descends, the stepped block A3 can move forwards with a predetermined distance. The heights each time the positioning post A2 operates are reduced regularly so that a plurality of heat dissipating sheets C can be assembled to the heat conductive tube B with predetermined spacing.

By above mentioned portion structure, it is discovered after long time test, although a plurality of heat dissipating sheets can be assembled to the heat conductive tube with predetermined spacing therebetween by the stepped movement of the stepped block to control the height of the positioning post A2, when the spacing for combining the heat dissipating sheets is necessary to be changed, another stepped block A3 must be used to update the old one. The process is complicated in the identification and more time is necessary for the operation. Moreover, when the positioning post A2 punches the stepped block A3, the collision force will induce the errors in precision and the noise in manufacturing. Furthermore, the stepped block confines the stepped distance for changing the spacing between the heat dissipating sheets. Thereby the heat dissipating sheet can be arranged densely.

### SUMMARY OF THE INVENTION

The object of the present invention is to improve above mentioned defect. In the present invention, the assembly of the heat conductive tube and heat dissipating sheet is design to cause that when the heat conductive tubes pass through heat dissipating sheets of different specifications. The spacing between the heat dissipating sheets can be adjusted easily. Furthermore, the shift in the connection between the heat conductive tube and the heat dissipating sheet can be reduced and the noise is decreased. Thus, the heat dissipating sheet C can be arranged densely.

To achieve above object, the present invention provides device for assembling a heat conductive tube to a heat dissipating plate which comprises a retaining seat; a transmission device; a displace unit firmly secured to the retaining seat; the displace unit having a seat; a transmission element being installed to the seat; one end of the transmission element being extended to be out of the seat so as to be assembled to the transmission device; the transmission element being pivotally installed with a movable unit; a guide unit firmly secured to the retaining seat; the guide unit having a guide track and a movable block slideable upon the guide track; and a carrying unit having a connecting block, a supporting plate, an adjusting plate, and a locking element; the connecting block being firmly secured to the movable unit, and the movable block; the supporting plate being firmly secured to the connecting block; the adjusting plate being formed with a plurality of adjustment holes for receiving the locking element so that the locking element can be locked to the installing hole of the supporting plate.

The various objects and advantages of the present invention will be more readily understood from the following detailed description when read in conjunction with the appended drawing.

### BRIEF DESCRIPTION OF THE DRAWINGS

FIG. 1 is a schematic perspective view showing the assembly of the heat dissipating plate and the heat conductive tubes according to the present invention.

FIG. 2 is an exploded schematic view of FIG. 1.

FIG. 3 is another schematic perspective view showing the assembly of the heat dissipating plate and the heat conductive tubes according to the present invention.

FIG. 4 is a schematic view showing the use of the present invention.

FIG. 5 is a schematic view about another embodiment of the present invention.

FIGS. 6 and 7 are schematic views about the operation of FIG. 5.

FIG. 8 is a lateral schematic view of FIG. 5.

FIG. 9 is a schematic view of a further embodiment of the present invention.

FIG. 10 is a schematic view of FIG. 9.

FIG. 11 is a schematic view about the use of FIG. 9.

FIG. 12 is a schematic view about the assembly of prior art heat conductive tube and heat dissipating plate.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

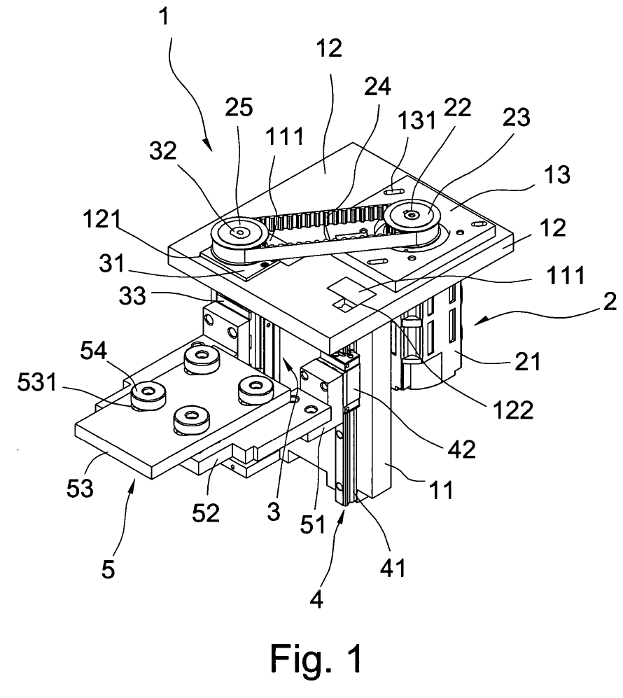

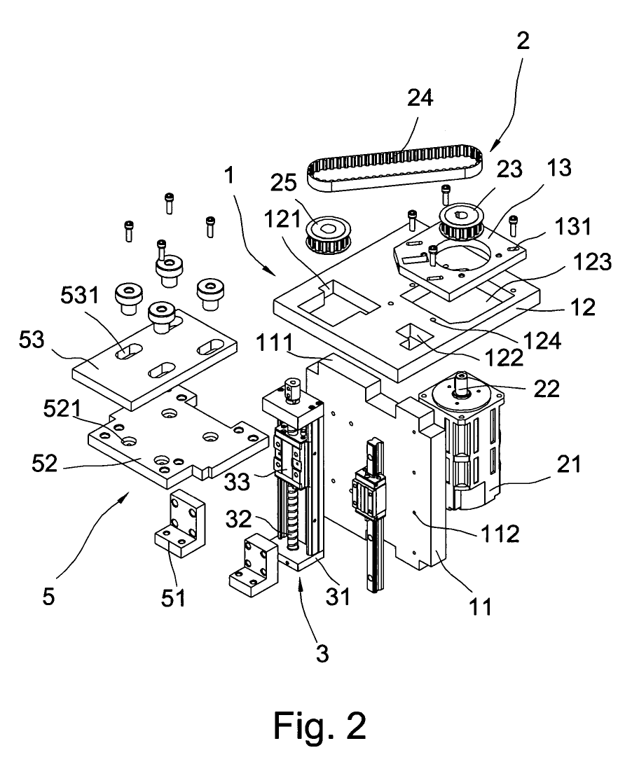

Referring to FIGS. 1, 2, and 3, the structure of the present invention is illustrated. The present invention includes the following elements.

A retaining seat 1 is formed with a first plate 11, a second plate 12, and a third plate 13. The first plate 11 is installed with a protrusion 111 for assembling the second plate 12. The first plate 11 has a plurality of retaining holes 122 for connecting a displace unit 3 and a guide unit 4. The second plate 12 has assembly holes 121, 122 for assembling the protrusion 111 of the first plate 11, the displace unit 3 and the guide unit 4. The second plate 12 also has a through hole 123. A periphery of the through hole 123 has a plurality of adjusting holes 131 for adjusting the position of the third plate 13 on the second plate 12 for adjusting a transfer unit 2.

The transmission device 2 has an actuating element 21. The actuating element 21 passes through the through hole 123 of the second plate 12 to be assembled to the third plate 13. Meanwhile, the transmission end 22 of the actuating element 21 passes through the third plate 13 to be assembled with the driven element 23 which is formed by a belt wheel. The driven element 23 serves to drive a passive element (belt wheel) 25 through a transmission element (belt) 24.

The displace unit 3 is firmly secured to the first plate 11. The displace unit 3 has a seat 31. The seat 31 is installed with a transmission unit 32 formed by a screw rod. One end of the transmission 32 extends out of the seat 31 to be assembled to the passive element 25. A movable unit 33 is pivoted to the transmission unit 32. When the transmission unit 32 is driven, the movable unit 33 is driven to displace upwards and downwards.

The guide unit 4 is firmly secured to the first plate 11. The first plate 11 is formed by a guide track 41 and a movable block 42 slidable on the guide track 41.

The carrying unit 5 includes a connecting block 51, a supporting plate 52, an adjusting plate 53, and a locking element 54. The connecting block 51 is firmly secured to the movable unit 33, and the movable block 42. The supporting plate 52 is firmly secured to the connecting block 51. The adjusting plate 53 is formed with a plurality of adjustment holes 531 for receiving the locking element 54 so that the locking element 54 can be locked to the installing hole 521 of the supporting plate 52. When the locking element 54 is released, the adjusting plate 53 is movable through the adjustment hole 531 so as to adjust a fixture (not shown) of a heat conductive tube. Preferably, the locking element 54 is made of ceramic material or acrylic material.

After assembly, the lateral sides of the first plate 11 and second plate 12 are connected with lateral plates 10 so as to complete the assembly work.

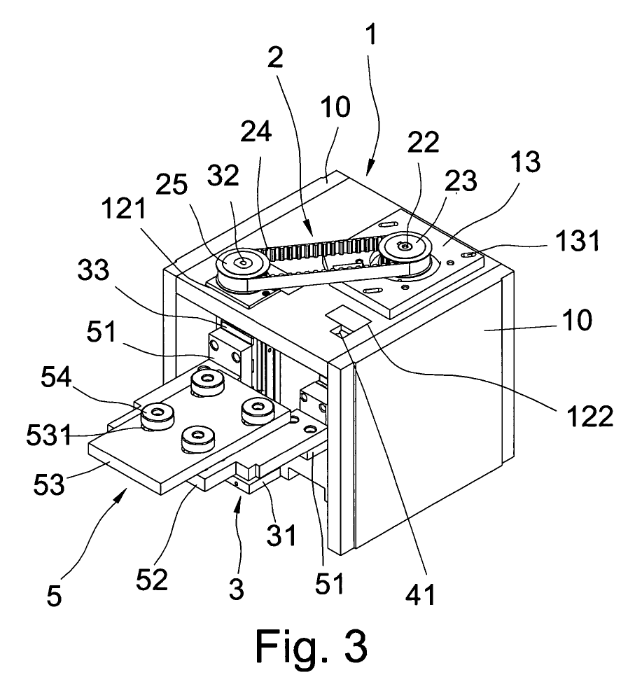

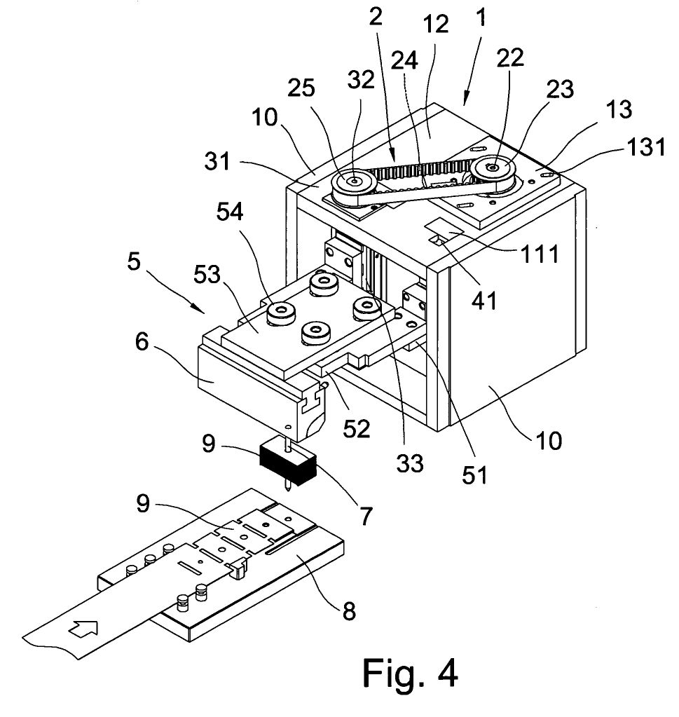

Referring to FIGS. 3 and 4, the use of the present invention is illustrated. In use of the present invention, at least one fixture 6 is firmly secured to the adjusting plate 53. The fixture 6 serves to fix a heat conductive tube 7. When the actuating element 21 of the transmission device 2 rotates, the driven element 23 is driven to drive the transmission element 24 and the passive element 25 to rotate. When the passive element 25 rotates, the transmission unit 32 of the displace unit 3 rotates. The movable unit 33 of the transmission unit 32 moves upwards and downwards.

When the movable unit 33 moves, by the connecting block 51 and the supporting plate 52, the movable block 42 of the guide unit 4 moves on the adjusting plate 53. Thereby the supporting plate 52 can drive the adjusting plate 53 and the fixture 6 to move upwards and downwards. Thereby the heat conductive tube 7 in the fixture 6 can be punched with the heat dissipating plate 9 on the punching platform 8 so that the heat dissipating plate 9 can be assembled to the heat conductive tube 7. When the operation has fault or interfered, the reaction force will transfer to the locking element 54. The left extension plate 53 may be destroyable threaded plunger which can be updated rapidly. Thereby the precision of the whole structure will not be affected and the cost is low.

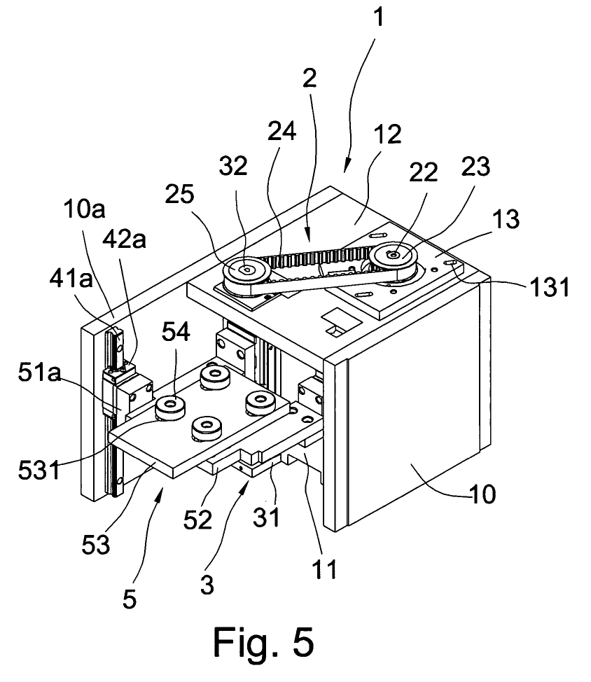

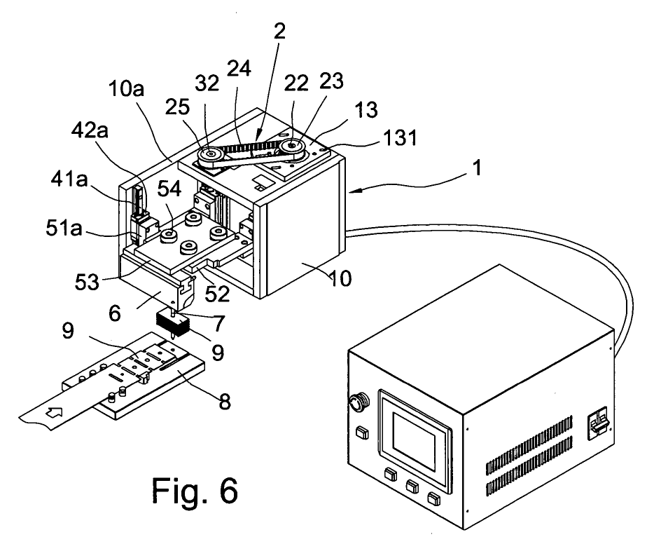

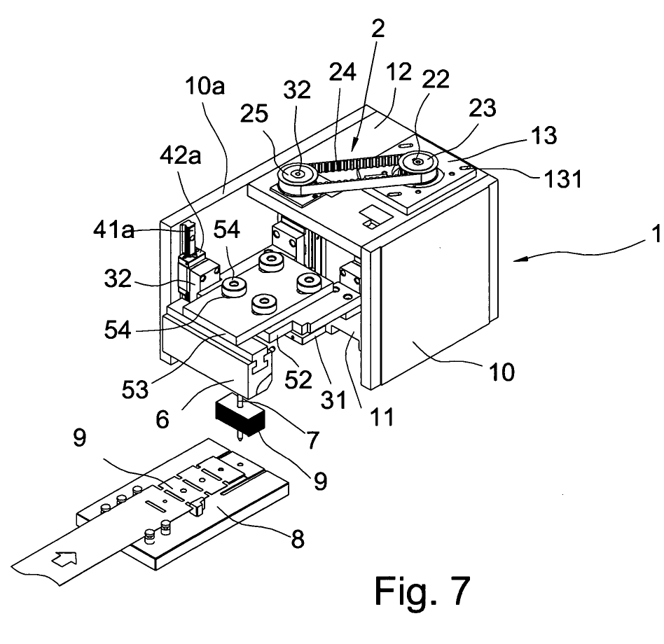

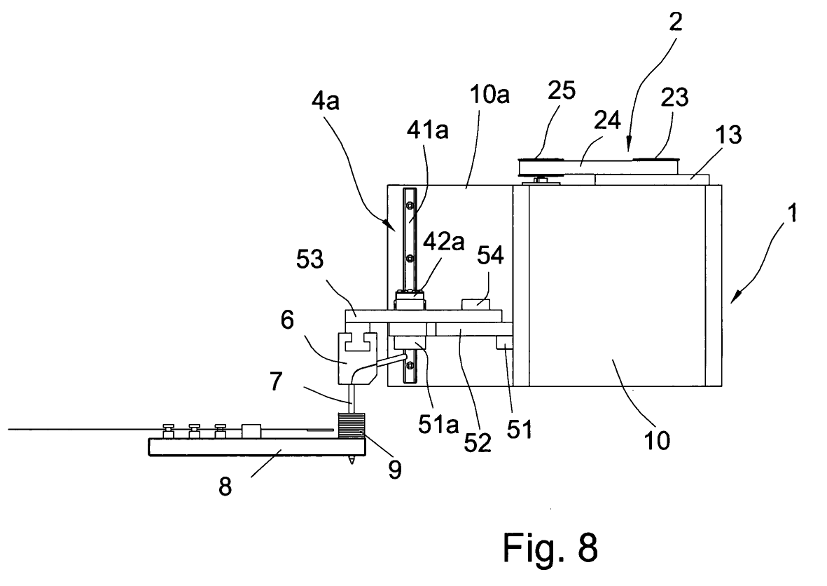

Referring to FIGS. 5 to 8, another embodiment of the present invention is illustrated. To make the carrying unit 5 to move longitudinally and steadily, a longer lateral plate 10a longer than the lateral plate 10 is added to one side of the carrying unit 5. A guide unit 4a and a connecting block 51a are installed to the lateral plate 10a. The guide unit 4a has a movable block 42a.

When the actuating element 2 of the transmission device 2 rotates, the driven element 23 is driven to rotate the transmission element 24 and the passive element 25. When the passive element 25 rotates, the transmission unit 32 of the displace unit 3 rotates, the movable unit 33 on the transmission unit 32 displaces longitudinally.

When the movable unit 33 moves, by the connecting blocks 51, 51a, and the supporting plate 52, the movable blocks 42, 42a of the guide units 4, 4a slide along the guide tracks 41, 41a so that the supporting plate 52 can drive the adjusting plate 53 and the fixture 6 to move longitudinally. Thereby the heat conductive tube 7 in the fixture 6 can be punched with the heat dissipating plate 9 on the punching platform 8 so that the heat dissipating plate 9 can be assembled to the heat conductive tube 7.

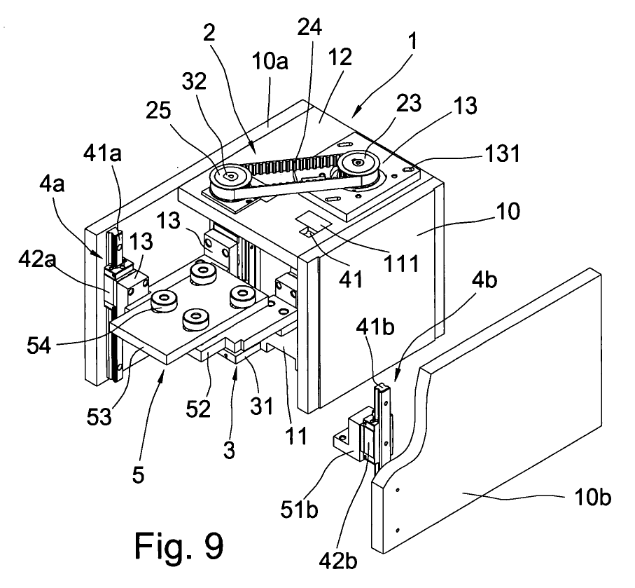

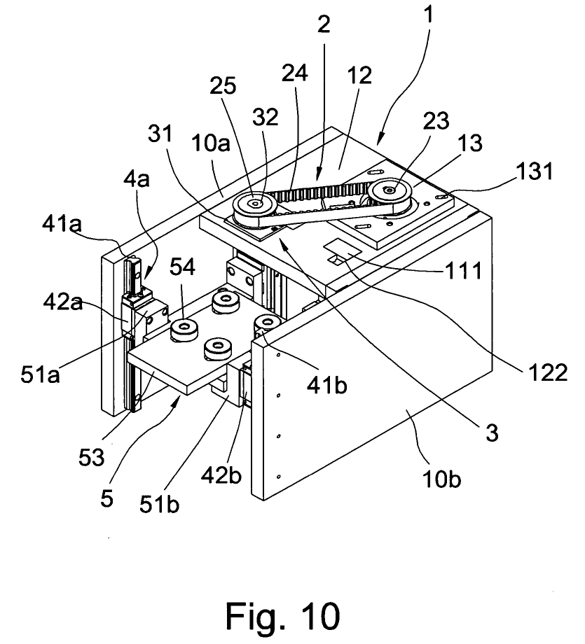

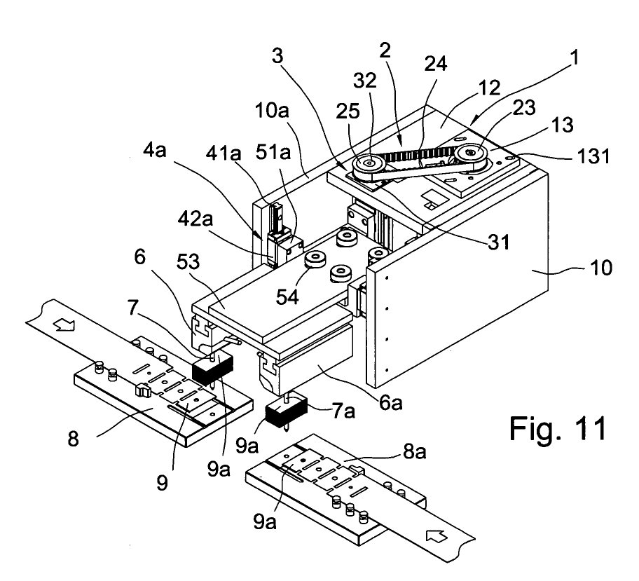

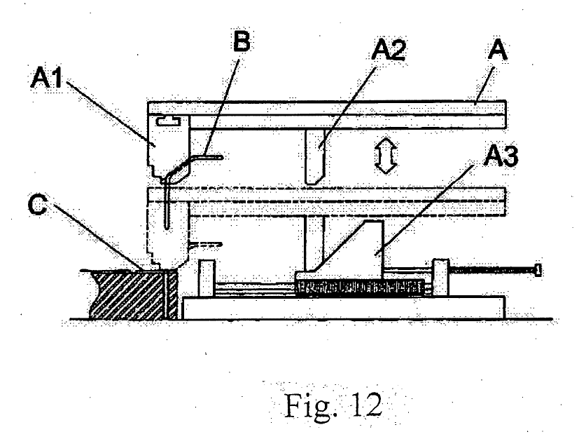

Referring to FIGS. 9, 10 and 11, a further embodiment of the present invention is illustrated. In this embodiment, a further lateral plate 10b is added aside of lateral plate 10. A guide unit 4b and a connecting block 51b are installed to the lateral plate 10b to be connected to the supporting plate 52.

When the actuating element 21 of the transmission device 2 rotates to drive the driven element 23 to rotate the transmission element 24 and the passive element 25, When the passive element 25 rotates, the transmission unit 32 of the displace unit 3 rotates, the movable unit 33 of the transmission unit 32 moves longitudinally.

When the movable unit 33 moves, by the connecting blocks 51, 51a, 51b and the supporting plate 52, the movable blocks 42, 42a, and 42b slides along the guide tracks 41, 41a and 41b. The guide track 41 can smoothly drive the adjusting plate 53 and the two fixtures 6, 6a to move longitudinally so that the two heat conductive tubes 7 clamped by the fixtures 6, 6a can pass through the heat dissipating plates 9, 9a punched by the two punching platform. Thereby the heat dissipating plates 9, 9a are inserted into the heat conductive tubes 7, 7a.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for assembling a heat conductive tube to a heat dissipating plate comprising:
a retaining seat;
a transmission device;
a displace unit firmly secured to the retaining seat; the displace unit having a seat; a transmission element being installed to the seat; one end of the transmission element being extended to be out of the seat so as to be assembled to the transmission device; the transmission element being pivotally installed with a movable unit;
a guide unit firmly secured to the retaining seat; the guide unit having a guide track and a movable block slideable upon the guide track; and
a carrying unit having a connecting block, a supporting plate, an adjusting plate, and a locking element; the connecting block being firmly secured to the movable unit, and the movable block; the supporting plate being firmly secured to the connecting block; the adjusting plate being formed with a plurality of adjustment holes for receiving the locking element so that the locking element can be locked to the installing hole of the supporting plate.

2. The device for assembling a heat conductive tube as claimed in claim 1, wherein the retaining seat is formed by a first plate, a second plate and a third plate which are connected as an integral body.

3. The device for assembling a heat conductive tube as claimed in claim 1, wherein the transmission device has an actuating element; the actuating element passes through the first plate and second plate to be connected to the driven element; the driven element serves to drive a passive element through the transmission element.

4. The device for assembling a heat conductive tube as claimed in claim 1, wherein the actuating element is a motor, the driven element is a belt wheel and the transmission element is a belt.

5. The device for assembling a heat conductive tube as claimed in claim 1, wherein the transmission unit of the displace unit is a screw rod.

6. The device for assembling a heat conductive tube as claimed in claim 1, wherein two sides of the retaining seat are assembled with lateral plates, respectively.

7. The device for assembling a heat conductive tube as claimed in claim 6, wherein the lateral plates are assembled with the guide unit.

8. The device for assembling a heat conductive tube as claimed in claim 7, wherein the guide unit is formed by a guide track and a movable block; and the movable block is assembled with a connecting block which is assembled to the supporting plate.

9. The device for assembling a heat conductive tube as claimed in claim 1, wherein the adjusting plate is assembled to at least one fixture.

10. The device for assembling a heat conductive tube as claimed in claim 1, wherein the locking element is a destroyable threaded plunger made of ceramic or acrylic material.
